(19) United States
(12) Patent Application Publication
(10) Pub. No.: US 2011/0239533 A1
(43) Pub. Date: Oct. 6, 2011

(54) PROCESS FOR GROWING MUSHROOMS

(76) Inventor: Ernest Leone, West Grove, PA (US)

(21) Appl. No.: 12/749,973

(22) Filed: Mar. 30, 2010

(51) Int. Cl. A01G 1/04

(52) U.S. Cl. 47/1.1

(57) ABSTRACT

The mushroom growing process includes various stages, such as phase I where compost is initiated and phase II where the process of conversion is started. These various stages include pasteurization and casing. In some processes there may be cacing which is another form of mycelium being added into the casing layer. The process of the present invention includes introducing an additive into the compost at one or more stages of the growing process. Such additive contains humic acid.

### BACKGROUND OF INVENTION

Production of the common cultivated mushroom, Agaricus bisporus, is a $909 million industry in the United States (USDA 2009). The mushroom is produced on a composted mixture of, for example, various cereal straws (wheat, rye, corn) hay, corncobs, distillers' grain, cottonseed meal, poultry manure and other raw materials.

### Phase I

Mushroom growing process starts with composting. Composting is a series of organic breakdown and heat generated from its own sources. The composting process takes roughly 4-5 weeks for the composting cycle. Compost is a very complex blend of nutrients such as hay, straw, cottonseed meal, cocoa hulls, gypsum, and any combination of chicken litter. These products are mechanically mixed together to achieve thermal activity in the makeup pile. This process is called phase I.

### Pasteurization

A mushroom house is approximately 8000 sq/ft of growing surface. Phase II process begins. Phase II is accomplished with a variation of fresh air and steam to start the process of conversion. Conversion means changing the ammonia produced from the compost to carbohydrates. When this is achieved phase III is then begun.

### Phase III

Mycelium is introduced into the completed phase II compost. Mycelium (spawn) and supplement consisting of added nutrients, protein and nitrogen, is then applied to the surface or mechanically introduced into this media. Mycelium is a chosen strain of fungus grown on a grain product such as millet, wheat, rye, soya, etc. The grain is the host of the mycelium. After the introduction of the spawn, the mycelium grows throughout the compost. After thoroughly grown, a new stage begins.

### Casing

Casing media, is a mixture of peat moss, spent mushroom compost, and lime to achieve a neutral PH. This is now applied to the compost surface approximately 1″-2″ thick layer. Now the stage is set for the fruiting of the mushroom. Controlled by cooler or warmer air temperatures, the spawn strands begin to rise to the surface engulfing the casing layer. Through variation of temperature and air movement the casing layer will form mushrooms. Harvesting is approximately 18-20 days after the casing process has been done.

As noted the preparation of compost occurs in two steps referred to as phase I and phase II composting. Phase I composting is initiated by mixing and wetting the ingredients as they are stacked in a rectangular pile. Normally the bulk ingredients are put through a compost turner. Mushroom compost develops as the chemical nature of the raw ingredients is converted by the activity of microorganisms, heat and some heat-releasing chemical reactions. The quality of raw materials used to make mushroom compost are highly variable and are known to influence compost performance in terms of spawn run and mushroom yield. Phase I composting generally lasts from 6 to 14 days, depending on the nature of the material at the start and its characteristics at each turn.

Phase II composting has two major purposes. Pasteurization is necessary to kill any insects, nematodes, pest fungi, or other pests that may be present in the compost. And second, it is necessary to condition the compost and remove the ammonia that formed during phase I composting. Ammonia at the end of phase II in a concentration higher than 0.07% is often inhibitory to mushroom spawn growth, thus it must be removed; generally, a person can smell ammonia when the concentration is above 0.10%. Phase II composting can be viewed as a controlled, temperature-dependent, ecological process using air to maintain the compost in a temperature range best suited for microorganisms to grow and reproduce. The growth of these thermophilic (heat-loving) organisms depends on the availability of usable carbohydrates and nitrogen, some of the nitrogen in the form of ammonia. These microorganisms produce nutrients or serve as nutrients in the compost on which the mushroom mycelium thrives and other organisms do not.

Nitrogen content of compost is positively correlated with mushroom yield. Some researchers have shown that during phases I and II, a high proportion of the total nitrogen in the compost is fixed in the humus-lignin fraction of the compost. About 80% of the insoluble nitrogen could be isolated from the lignin fraction.

### SUMMARY OF INVENTION

An object of this invention is to enhance the production of mushrooms.

In accordance with this invention an additive is applied to the compost at one or more stages in the growing process. The additive contains humic acid.

### DETAILED DESCRIPTION

The present invention is based upon the recognition that the addition of humic acid to the compost during the growing process will stimulate growth of the mushroom. Such additive could be incorporated into the compost at various stages of the process by being added in only one of the stages or by being added to multiple stages. For example, the additive could be dug into the compost during the early phases of the process or could be incorporated into the compost as a layer, such as being in peat moss during the casing stage of the process.

Preferably, the humic acid is included in an additive which comprises Leonardite. Leonardite is a low rank coal derived from prehistoric plant matter. Being a highly decomposed compressed natural organic humus that has been further processed by microbial activity. Leonardite has a high humic acid content which is one of the most bio-chemically active ingredients. The Leonardite can be obtained from a fresh or saltwater source and is applied in the compost substrate, preferably being applied in the compost substrate for the purpose of enhancing mushroom yield by volume or weight from increasing the available nutrients in the compost substrate. Humic acid applied at any stage of the mushroom or composting process shows a significant yield in mushroom production. The invention could be practiced in all strains of spawn mycelium including, but not limited to agaricus, portabella, oyster, shiitake, enoki, hybrid and non-hybrid spawn mycelium, cacing, sawdust media, for the purpose of increasing mushroom yield by volume or weight.

In a preferred practice of this invention the Leonardite containing humic acid is added to the compost in an amount of 2-3 pounds per cubic yard of compost. The invention could be practiced with greater or lesser amounts, such as a range of 2-4 or 1-4 or 2-6 or 1-6 pounds per cubic yard.

When the humic acid is incorporated into the composting process at various stages, there has been an increased yield and better quality mushrooms. The addition of humic acid at any time during the composting process yields greater poundage and quality. The humic acid can be introduced into the crop in various manners. For example, the humic acid additive could be incorporated during spawn manufacturing, casing media, supplementation, spawning, and cacing which is another form of mycelium added into the casing layer.

When applied directly to the compost, such as during phase I, the humic acid additive could be dug into the compost. The humic acid could be incorporated in a conventional spawn or conventional supplement and dug into the compost.

The humic acid could be incorporated in a casing layer applied over the compost.

Although additives that influence the composting process and that benefit yield are of great interest to mushroom growers and although Leonardite has received attention from growers of non-mushroom crop, the present inventor is unaware of any earlier suggestions for using humic acid, such as in a Leonardite additive, where such use is in the mushroom growing process to stimulate growth.

In order to evaluate the benefits of humic acid, the following tests were conducted using Hydra-Hume (HH), a Leonardite product supplied by Helena Chemical Company. This product is a humic acid formulation that contains long chain organic molecules. The following evaluates this material in various phases of the production cycle and its effect on mushroom yield. The tests were conducted at The Pennsylvania State University (Penn State).

The objective of these tests is to determine the effect of Hydra-Hume added to compost on yield of Agaricus bisporus.

### Procedures

Completely randomized; Use bins; 55 lb (25 kg)/bin

TABLE 1
Treatments of Hydra Hume applied

| | | | Commercial |
|---|---|---|---|
| | | | supplement |
| Trt. | | | at spawning |
| No. | Compost phase | Amount Hydra-Hume | (% dry wt) |
| 1 | Phase I at build | 3 lb/yd³ compost | 4 |
| 2 | Phase I at build | 6 lb/yd³ compost | 4 |
| 3 | Phase II at fill | 3 lb/yd³ compost | 4 |
| 4 | Phase II at spawning | 5% of substrate dry wt* | 4 |
| 5 | Control-Phase II at spawning | None | 4 |

*Compost typically contains 70% moisture.

1. Prepare mushroom compost using standard procedures at Mushroom Test Demonstration Facility (MTDF) of Penn State.
2. Add material at appropriate stage of production cycle.
3. Make compost, spawn and supplement substrate.
4. Collect samples of treated compost for analysis.
5. Use 11 replicates (bins)/treatment. Total 55 bins (11 reps×5 treatments)−1 less replicate for treatment No. 5.
6. Use 150 g spawn/replicate (bin).
7. Use Sylvan 140 off-white hybrid spawn.
8. Produce mushrooms using standard procedures at Mushroom Research Center of Penn State.
9. Harvest, weigh and count mushrooms daily from each bin at Mushroom Research Center of Penn State.

### Results

Analyses of selected compost factors for Crop 0908 where HH was incorporated into compost at various stages and rates are presented in Table 2. pH values were similar among all treatments, ranging from 7.6 to 7.5. Soluble salts also were very similar. Moisture contents varied from a low of 67.3% in treatment 4 to a high of 72% in treatment 1. Nitrogen (N) contents varied from a low of 2.1% in treatment 4 to a high of 2.3% in treatments 2 and 3. Carbon:Nitrogen ratios were very similar across treatments.

TABLE 2
Analysis of selected compost factors for Crop
0908 where Hydra Hume was incorporated into compost at
various stages and rates.

| | Analyte | | | | | | |
|---|---|---|---|---|---|---|---|
| | | | Mois- | | | Car- | |
| Trt. | | | ture | Organic | Nitrogen | bon | Carbon:Nitrogen |
| No.^{a} | pH | SS^{b} | (%) | matter | (%) | (%) | Ratio |
| 1 | 7.6 | 11.26 | 72.0 | 77.6 | 2.2 | 40.8 | 18.4 |
| 2 | 7.6 | 12.95 | 71.8 | 77.3 | 2.3 | 39.7 | 17.4 |
| 3 | 7.5 | 10.51 | 69.7 | 76.7 | 2.3 | 42.6 | 18.3 |
| 4 | 7.5 | 10.89 | 67.3 | 77.8 | 2.1 | 40.9 | 19.3 |
| 5 | 7.5 | 10.25 | 68.1 | 77.7 | 2.2 | 40.0 | 18.3 |

^{a}See Table 1 for treatment descriptions.
^{b}Soluable salts (1:5 w:w).

Yield and biological efficiency (BE %) of mushrooms produced on compost amended with Hydra Hume at various stages and rates is presented in Table 3. Yields varied from a high of 29 kg/m² in treatment 4 to a low of 23.79 kg/m² in treatment 1 (21.9% difference). On the other hand, BEs ranged from a high of 100.9% in treatment 3 to a low of 88.2% in treatment 5 (control).

TABLE 3
Yield and biological efficiency (BE %) of mushrooms produced on
compost amended with Hydra Hume at various stages and rates.

| Trt. No.^{a} | Yield (kg/m²) | BE (%)^{b} |
|---|---|---|
| 1 | 23.79c | 91.7bc |
| 2 | 25.77bc | 98.7ab |
| 3 | 28.32a | 100.9a |
| 4 | 29.00a | 95.8ab |
| 5 (control) | 26.06b | 88.2c |

^{a}See Table 1 for treatment descriptions.
^{b}Biological efficiency is defined as the ratio of mushrooms harvested (fresh wt)/dry substrate wt and expressed as a percentage.

### Discussion

Analysis of selected compost factors revealed that most values were similar, expect for moisture content. Since phase II compost is spawned into trays by weight, spawning dryer compost results in higher dry substrate weights/tray. Higher dry substrate weighs/tray, in turn, influences both yield and BE. In cases where substantial variation exists in yield expressed in kg/m², it often is more beneficial to use BE as a measure of yield performance since calculations for BE include moisture content of the substrate.

Highest yielding treatments (kg/m²) were observed in treatments 3 & 4 (HH added at fill and at spawning, respectively) and these treatments were significantly higher than the other treatments. BEs for treatments 2, 3, & 4 (HH added at phase I build, phase II at fill, and phase II at spawning, respectively) were significantly higher (98.7%, 100.9% & 95.8%, respectively) than the control (treatment 5) containing no HH (88.2%).

At time of spawning treatment 3 had more fire fang or thermophilic bacteria and fungi present within the compost. Growers often associate the presence of more fire fang with higher mushroom yields. Thus, it appears that HH may have an influence on the growth and reproduction of thermophiles within the compost pile.

The presence of saprophytic nematodes in some replicates of treatment 1. Saprophytic nematodes may depress yield, so this may have been partly responsible for reduced yield and BE compared to treatment 2 where higher levels of HH were used. Treatment 1 was at the front of the pasteurization tunnel where temperatures may be slightly lower than the rest of the tunnel. Thus, inadequate pasteurization may have resulted in some nematode eggs surviving the pasteurization process.

There was no attempt to analyze the emission of odors from compost containing HH. However, growers may benefit from the use of HH to help reduce odor emissions. Given, the fact that HH resulted in higher yields, the suppression of odor emissions may be an extra benefit to growers.

What is claimed is:

1. In a process for growing mushrooms wherein the mushrooms are produced on a compost, the compost being treated in a phase I step and in a phase II step, mycelium being introduced into the completed phase II compost in a phase III step, and applying a casing media when the mycelium grows in the compost, the improvement being in applying an additive to the compost during the growing process to stimulate growth, and the additive containing humic acid.

2. The process of claim 1 wherein the additive is Leonardite.

3. The process of claim 2 wherein the Leonardite is obtained from a fresh or saltwater source.

4. The process of claim 2 wherein the Leonardite is added in an amount in the range of 2-3 pounds per cubic yard of compost.

5. The process of claim 1 wherein the mycelium is a strain of spawn mycelium selected from the group consisting of agaricus, portabella, oyster, shiitake, enoki, hybrid and non-hybrid spawn mycelium, cacing and sawdust media.

6. The process of claim 1 wherein the additive is dug directly into the compost.

7. The process of claim 1 wherein the additive is incorporated in spawn which is dug directly into the compost.

8. The process of claim 1 wherein the additive is incorporated in a supplement which is dug directly into the compost.

9. The process of claim 1 wherein the additive is incorporating in a casing layer which is applied over the compost.

10. The process of claim 1 wherein the additive is applied during at least one stage selected from the group consisting of phase I, phase II, phase III and casing.

11. The process of claim 10 wherein the additive is applied in at least two of the stages.

12. The process of claim 10 wherein the additive is applied in at least three of the stages.

13. The process of claim 10 wherein the additive is applied in all of the stages.

14. The process of claim 1 wherein the additive is applied during a cacing step.
